(19) United States
(12) Patent Application Publication
(10) Pub. No.: US 2026/0057667 A1
(43) Pub. Date: Feb. 26, 2026

(54) AUTONOMOUS FLIGHT SYSTEM USING ARTIFICIAL INTELLIGENCE-BASED EDGE COMPUTING

(71) Applicant: DUSITECH CO., LTD., Daejeon (KR)

(72) Inventors: Jin Ho JEONG, Sejong (KR); Young Hi PARK, Sejong (KR); Jin Mo PARK, Daejeon (KR); Sung Hyun PARK, Sejong (KR); Yu Mi JEONG, Sejong (KR)

(21) Appl. No.: 19/344,457

(22) Filed: Sep. 29, 2025

Related U.S. Application Data
(63) Continuation of application No. PCT/KR2025/012720, filed on Aug. 21, 2025.

(30) Foreign Application Priority Data
Aug. 23, 2024 (KR) 10-2024-0113647

(51) Int. Cl. G06V 20/17; B64U 20/80; G06T 3/40; G06T 7/246; G08G 5/26; H04N 7/18; H04N 23/695

(52) U.S. Cl. CPC G06V 20/17; B64U 20/80; G06T 3/40; G06T 7/246; G08G 5/26; H04N 7/185; H04N 23/695; B64U 2201/10; G06T 2207/10016; G06T 2207/10032

(57) ABSTRACT

Disclosed is an autonomous flight system using artificial intelligence-based edge computing, the autonomous flight system including a mission apparatus configured to perform both image processing and object detection to generate metainformation including time coordinates of an object, a drone configured to apply a predetermined format and specifications to video including the metainformation to generate low-capacity data, and a ground controller configured to restore the low-capacity data to recognize a pre-learned object utilizing the metainformation, when a specific object is designated, to enhance the resolution of an image including the specific object, and to provide the image to the drone for object tracking.

### TECHNICAL FIELD

The present invention relates to an autonomous ‘flight system using artificial intelligence-based edge computing, and more particularly to technology related to an autonomous flight system that includes a mission apparatus, a drone, and a ground controller and that performs object detection or tracking using artificial intelligence-based edge computing.

### BACKGROUND ART

Until now, a method of estimating position and posture based on the GPS values of the flight position of a drone and the image and posture values from a camera gimbal has mainly been used for drone image processing.

Upon receiving the position and the posture values directly from the camera, HD or FHD resolution camera video is processed as the posture value of an encoder; however, this method has limitations as position and posture are provided using PID posture control values, which have low physical response speed.

Generally, a method of ground control equipment wirelessly receiving an image of mission equipment of the camera and flight information of the drone and calculating and utilizing the coordinates of the position captured by the drone is used.

Furthermore, in existing systems, the position of the drone, the viewing distance of the camera, angle, and posture values are acquired based only on the drone, or the position is estimated by the ground control equipment after image transmission.

In addition, image data transmitted from the drone often suffers from irregular transmission specifications or significant errors due to transmission delay, caused by low resolutions like HD or FHD and low-quality compression codecs, such as H.264.

In order to solve this problem, it is necessary to synchronize a real-time high-resolution image supporting autonomous flight by the camera and to integrally perform image, metainformation, and artificial intelligence processing.

Consequently, conventional drone-based image acquisition technology has evolved from initial low-resolution systems to current high-resolution systems comparable to mobile phones, enabling day and night exploration.

Currently, there is a constant demand for technologies to miniaturize and transmit large-capacity videos for processing high-resolution images acquired by drones, while simultaneously enabling the precise recognition of multiple objects and providing real-time object coordinates. However, solutions thereto have not yet been proposed.

In particular, with recent application of artificial intelligence technology to drones, the importance of precisely identifying position and time information captured by a drone camera, along with an object in an image, has been highlighted, and there is a growing demand for more precise position information acquisition from drones by synchronizing the image with the exact time using the accurate geographic coordinates of natural or artificial objects and real-time time information when the object in the real-time image viewed by the drone is moving. However, image processing, data synchronization, and ground control command methods are not utilized due to difficulty in practical application.

A passive control algorithm method in which a drone moves toward predetermined coordinates while avoiding obstacles using a collision avoidance sensor under control of an operator who operates the drone is generally used as the current drone autonomous flight technology.

This structure operates under direct one-to-one operator control. However, demand for drone systems with autonomous flight capabilities is steadily increasing, particularly for drone systems that have learning functions and that can independently search for and move to designated objects.

In order to solve this problem, active research is underway to develop multi-autonomous flight systems in which an AI drone is equipped with a low-power, subminiature edge computer and a high-resolution camera, enabling clear object tracking across large areas.

However, most research consumes significant energy due to high-resolution image signal processing and AI computing, and these systems typically weigh 10 to 20 kg, making it difficult to move beyond the research stage and hindering technological commercialization and miniaturization.

Meanwhile, Patent Document 1, as a prior art document, relates to an unmanned aerial vehicle for acquiring precise position data during high-speed flight and a method of synchronizing unmanned aerial vehicle mission equipment to acquire precise position data during high-speed flight.

Patent Document 1 is an invention concerning factors causing positional errors during drone (unmanned aerial vehicle) photography, and the prior art is a synchronization method in photography required for three-dimensional modeling using a drone.

Patent Document 1 relates to a synchronization method for correcting and remedying errors in determining the data acquisition position. Patent Document 1 relates to a method of synchronizing unmanned aerial vehicle mission equipment to acquire precise position data during high-speed flight, wherein visual synchronization is performed based on the real-time operating system of a flight control computer, and a real-time operating system architecture optimized for the unmanned aerial vehicle is installed in the flight control computer such that a general flight controller (FC) and a flight control computer (FCC) are mutually linked and operate together based on synchronization of a predetermined time (e.g., 1 ms).

Accordingly, Patent Document 1 relates to a method for determining the position of a photographic image by synchronizing the determination of the photographing position with GPS information based on the photographing path of the drone, which enhances the positional accuracy of photography.

Patent Document 2 relates to an automated apparatus for deploying a ground reference point based on drones for generating digital maps of earthwork sites and a method of photographing, through RTK technology, the deployment of a virtual reference point for creating a three-dimensional digital map using RTK correction technology with centimeter-level precision due to significant GPS errors.

In Patent Document 2, a flight controller and a flight control computer of a drone are equipped with onboard control image communication such that the drone flight control computer performs synchronization based on video, metainformation for obtaining the position coordinates of an object in the drone camera video is acquired from the image, and the same is transmitted to a smart controller. The smart controller acquires a pre-learned object using an artificial intelligence algorithm based on the image and the metainformation and calculates the position coordinates of the object in the video.

The video MPEG transmitted from the drone, including H.264 having a low resolution of HD and metainformation, is received by an onboard computer of the smart controller, which has a low signal processing speed, and a video transmission method has a computer function of simultaneously transmitting the video to both a ground control system (GCS) and an artificial intelligence processor.

The ground control system analyzes the MPEG to utilize the video and the metainformation alongside a geographic information system, and therefore the artificial intelligence processor may recognize the object in the video and acquire the position coordinates of the metainformation through a machine learning engine.

This method identifies the coordinates of the video synchronized with the time and position of the camera's angle during movement, rather than an image at the current time, as the position of the image synchronized with the time and position of the drone camera's viewpoint.

Therefore, Patent Document 2 provides a method of implementing real-time video frames displayed at actual position coordinates using an onboard flight control computer mounted on the drone and an onboard server of the smart controller and serving as a coordinate synchronization technology at the time of video capture.

Furthermore, in order to enhance the precision of position information in the video from the drone, a separate global navigation satellite system (GNSS) correction technology called RTK synchronization technology is applied; however, this only improves the precision of the position of the drone.

When different apparatuses (the camera, the drone, the flight controller, etc.) are interconnected in order to acquire information necessary for real-time camera viewpoint calculation, such as GPS time, position coordinates, camera information, fused standard posture information of drone and gimbal postures, precise angles, altitude, and flight control information, cumulative integration errors in the acquired information occur with data latency.

Furthermore, a mission apparatus mounted on the drone is an ultra-compact edge computer including a 48-megapixel (48MP) camera, a VGA IR sensor, and a posture sensor and a distance sensor configured to easily calculate the camera's viewing position, and in a redundant real-time high-speed signal processing method and a method of processing the metainformation included in the image, high power consumption is necessary to process large-capacity 4K video and the IR sensor, and the size of a large electronic board for signal processing is reduced such that a gimbal can control the camera's viewing position.

An analog or HDMI communication method is predominantly used as the existing video transmission method, and this is an image dump approach of transmitting an image according to the same specifications regardless of data increase during drone movement. This approach may not include metainformation, and when information including metainformation is converted to analog HDMI, the metainformation included in the video frames is deleted, which is a video format unusable for coordinate recognition.

Furthermore, to enhance the precision of position information in drone video, a separate global navigation satellite system (GNSS) correction technology called RTK synchronization technology, is applied; however, this only improves the precision of the drone's position, and when different apparatuses are connected to each other, as described above, cumulative integration errors in the acquired information occur with data latency.

In addition, conventionally, the current video frame is transmitted as compressed information representing changes from the previous frame, and therefore each frame lacks precise time and position information and when transmitted wirelessly from the drone, the increased data volume of specific frames causes delays. Consequently, even when object identification is performed, accurate position identification is difficult, resulting in errors of several hundred meters. Furthermore, when the drone has no metainformation, the position of the video frame viewed by the camera has a continuous sequence of images based on changes from the previous video, it is not possible for an operator to determine the time and position based on the video frame the operator sees after transmission of the image.

Integrating video processing with metainformation requires high-performance computers on board drones to achieve precise synchronization including posture and field of view, along with metainformation and video fusion. However, implementing server configurations operable on small drones and computer fusion technologies capable of both video generation and metainformation processing is difficult, when signal processing is distributed, latency issues arise, and when the volume of video frames changes significantly, video transmission may be delayed due to a limited frequency bandwidth in a wireless communication period or due to CPU processing limitations.

As such, the conventional method suffers from unsynchronized video processing due to data integration through various peripheral interfaces on drones, and digital images with metainformation containers suffer from damage to video and metainformation when converted to a HDMI or analog format. Furthermore, there are problems with automatic adjustment of video wireless traffic transmitted from drones and communication delays when large volumes of data are transmitted over limited communication frequencies.

Therefore, the conventional method relies on ground control equipment to estimate positions and recognize objects based on images and flight information to control the drone; however, this approach suffers from errors in resolution and positional accuracy, and signal processing is difficult in miniaturized drones.

### CITATION LIST

### Patent Document

(Patent Document 1) Republic of Korea Patent No. 10-1943823
(Patent Document 2) Republic of Korea Patent No. 10-2417591

### DISCLOSURE

### Technical Problem

The present invention has been made in view of the above problems, and it is an object of the present invention to provide an autonomous flight system that includes a mission apparatus, a drone, and a ground controller, that performs drone-centric image processing and object coordinate acquisition based on the mission apparatus, and that performs object detection or tracking using artificial intelligence-based edge computing.

It is another object of the present invention to provide an autonomous flight system to which AI-capable specifications are applied.

It is another object of the present invention to provide an autonomous flight system configured such that a mission apparatus detects an image signal to generate video, generates metainformation using gimbal information about the posture of the mission apparatus and flight information of a drone, learns the video and the metainformation to detect an object, and temporally synchronizes the coordinates of the detected object to generate metainformation including time coordinates of the object.

It is another object of the present invention to provide an autonomous flight system configured such that the drone generates low-capacity data by applying an SRT protocol using bit rate techniques and frame rate specifications to the video including the metainformation.

It is a further object of the present invention to provide an autonomous flight system that restores the video utilizing the format and the specifications applied to the low-capacity data, recognizes an object pre-learned by the mission apparatus utilizing the metainformation, when a specific object is designated, enhances the resolution of an image including the specific object to generate a designated image, and provides the designated image to the drone for real-time tracking of the specific object.

### Technical Solution

An autonomous flight system using artificial intelligence-based edge computing according to an embodiment of the present invention to achieve the above objects includes a mission apparatus (100) configured to detect an image signal to generate video, to generate metainformation using gimbal information about the posture of the mission apparatus and flight information of a drone, to learn the video and the metainformation to detect an object, and to temporally synchronize coordinates of the detected object to generate metainformation comprising time coordinates of the object, a drone (200) configured to apply a predetermined format and specifications to the metainformation and the video to generate low-capacity data and to transmit the low-capacity data to a ground controller within a limited frequency band, and a ground controller (300) configured to restore the video utilizing the format and the specifications applied to the low-capacity data, to recognize an object pre-learned by the mission apparatus utilizing the metainformation, when a specific object is designated, to enhance the resolution of an image including the specific object to generate a designated image, and to provide the designated image to the drone for real-time tracking of the specific object, wherein the mission apparatus, the drone, and the ground controller perform object detection or tracking using artificial intelligence-based edge computing.

The mission apparatus may directly process the image and the metainformation to reduce image signal loss or transmission delay and detect an object in advance to increase accuracy of object recognition at the ground controller, the drone may provide low-capacity data to which the predetermined format and specifications are applied to the ground controller to reduce transmission delay or video stuttering within a limited bandwidth, and the ground controller may transmit the designated image to the drone within a predetermined time by restoring the video and recognizing a pre-learned object.

The drone may generate low-capacity data by applying an SRT protocol using bit rate techniques and frame rate specifications to the video including the metainformation, thereby performing swarm communication with neighboring drones and sharing a limited frequency band.

When the specific object is designated, the ground controller may learn feature points of a pre-learned object to search for the specific object, enhance the resolution of an image including the searched specific object to generate a designated image, and provide information regarding the coordinates of the specific object and the designated image to the drone, and the drone may track the specific object utilizing the coordinates of the specific object and the designated image provided by the ground controller, and if the specific object moves during an autonomous flight tracking process, fuse metainformation acquired during the tracking process with the image of the mission apparatus.

### Advantageous Effects

In accordance with the present invention, the mission apparatus may directly process an image and the metainformation to reduce image signal loss or transmission delay, and may detect an object in advance to increase the accuracy of object recognition at the ground controller.

In accordance with the present invention, the drone may provide low-capacity data to which a predetermined format and specifications are applied to the ground controller, thereby reducing transmission delay or video stuttering within a limited bandwidth.

In accordance with the present invention, the ground controller may transmit a designated image to the drone within a predetermined time by restoring the video and recognizing the pre-learned object, and the continuity of object tracking may be guaranteed through rapid transmission.

In accordance with the present invention, the drone generates low-capacity data by applying an SRT protocol using bit rate techniques and frame rate specifications to video including metainformation, thereby performing swarm communication with neighboring drones and sharing a limited frequency band.

### DESCRIPTION OF DRAWINGS

FIG. 1 is a perspective view showing a mission apparatus having both an image processing function and an object detection function according to an embodiment of the present invention.

FIG. 2 is a left side view and a right side view showing the mission apparatus of FIG. 1.

FIG. 3 is a perspective view showing the interior of an image processing unit in the mission apparatus of FIG. 1.

FIG. 4 is a block diagram showing an imaging apparatus of FIG. 1 in detail.

FIG. 5 shows an autonomous flight system using artificial intelligence-based edge computing according to an embodiment of the present invention.

FIG. 6 is an example of adjusting a roll angle of the mission apparatus.

FIG. 7 is an example of adjusting a pitch angle of the mission apparatus.

FIG. 8 is an example illustrating the operation for automatically aligning the angle of the mission apparatus.

FIG. 9 is an example of controlling a BLDC motor according to posture control based on viewing angles of dual cameras.

FIG. 10 is an example of filtering raw data of a posture sensor.

FIG. 11 is an example of an object recognition experiment utilizing the mission apparatus of the present invention.

FIG. 12 is an example showing a primary model to a tertiary model of the mission apparatus.

FIG. 13 shows an example in which the mission apparatus of FIG. 1 is coupled to a drone.

FIG. 14 shows an autonomous flight system using artificial intelligence-based edge computing according to another embodiment of the present invention.

FIG. 15 shows an autonomous flight system using artificial intelligence-based edge computing according to yet another embodiment of the present invention.

FIG. 16 is an example showing an operational overview of the autonomous flight system using artificial intelligence-based edge computing according to the present invention.

FIG. 17 is an example showing the mission apparatus to which an artificial intelligence algorithm for distance estimation and object recognition is applied.

### BEST MODE

Hereinafter, embodiments of the present invention will be described in detail with reference to the accompanying drawings and the contents described therein; however, the present invention is not limited or restricted by the embodiments.

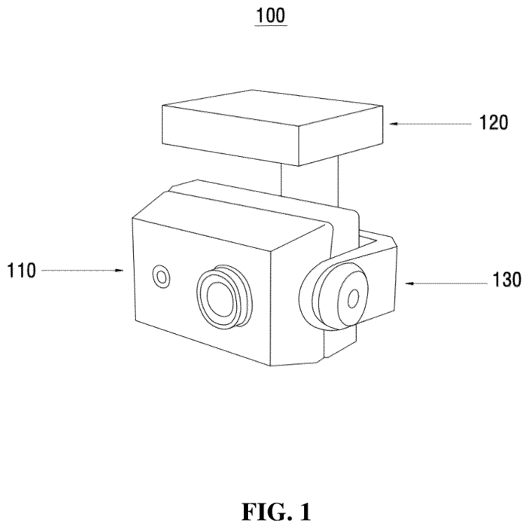

FIG. 1 is a perspective view showing a mission apparatus having both an image processing function and an object detection function according to an embodiment of the present invention, wherein the mission apparatus 100 has a function of capturing an image and a function of detecting an object from the image.

The mission apparatus 100 refers to an apparatus performing tasks for specific purposes such as disaster, missing person search, or bridge crack, wherein the mission apparatus may be coupled to a driving apparatus and moved by the driving apparatus. The driving apparatus refers to an apparatus capable of driving over land, sea, or air, and a representative example of the driving apparatus is a drone; however, the present invention is not limited thereto.

The mission apparatus 100 includes an image processing unit 110, a posture control unit 120, and a posture adjustment unit. The image processing unit 110 detects an image signal to generate video, generates metainformation using gimbal information about the posture of the image processing unit and driving information about the driving of the driving apparatus, and processes the video and the metainformation according to a predetermined format. When the driving apparatus is a drone, driving information refers to flight information.

The posture control unit 120 receives the gimbal information from the image processing unit 110, and generates posture adjustment control information using the gimbal information. The posture adjustment unit 130 connects the image processing unit 110 and the posture control unit 120 to each other, and adjusts the posture of the image processing unit 110 using the posture adjustment control information.

The posture adjustment control information is information configured to adjust the X-axis and Y-axis postures of the image processing unit 100. The posture adjustment control information may include information configured to adjust the Z-axis posture depending on the type of driving apparatus.

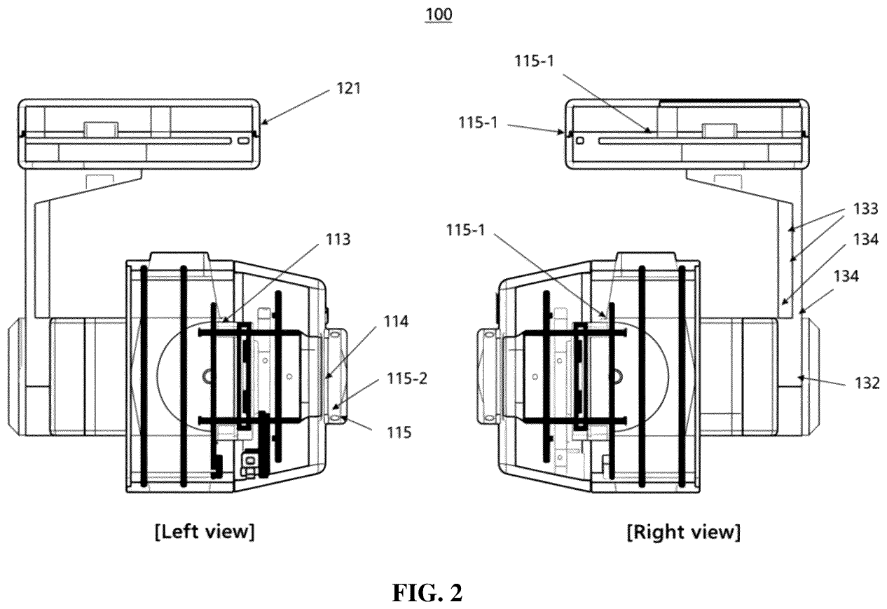

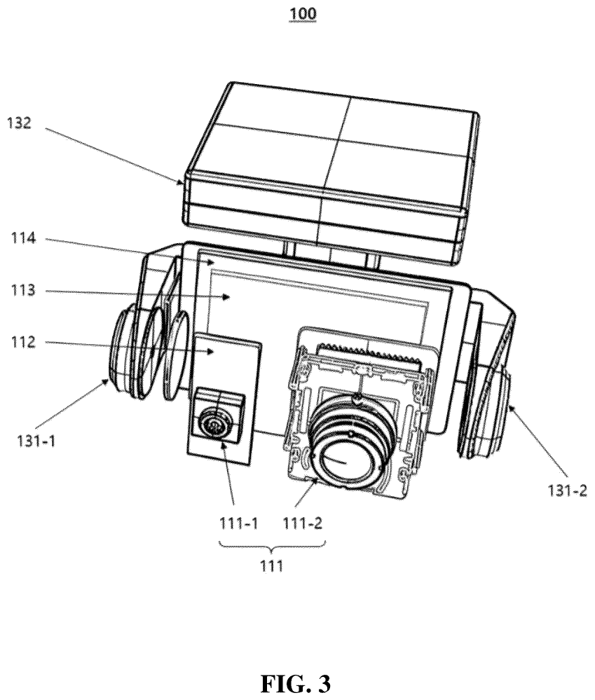

FIG. 2 is a left side view and a right side view showing the mission apparatus of FIG. 1, and FIG. 3 is a perspective view showing the interior of the image processing unit in the mission apparatus of FIG. 1, wherein the image processing unit 110 includes an image sensor unit 111, an image input/output board 112, an interface board 113, and edge computing board 114, and a first case 115.

The image sensor unit 111 includes an EO sensor 111-1 and an IR sensor 111-2 configured to detect an image signal. The EO sensor 111-1 stands for electro-optical sensor, and the IR sensor 111-2 stands for infrared sensor.

The image sensor unit 111, which is constituted by the EO sensor 111-1 and the IR sensor 111-2, may capture an image of a target object regardless of day or night, and may generate an image for object detection or tracking.

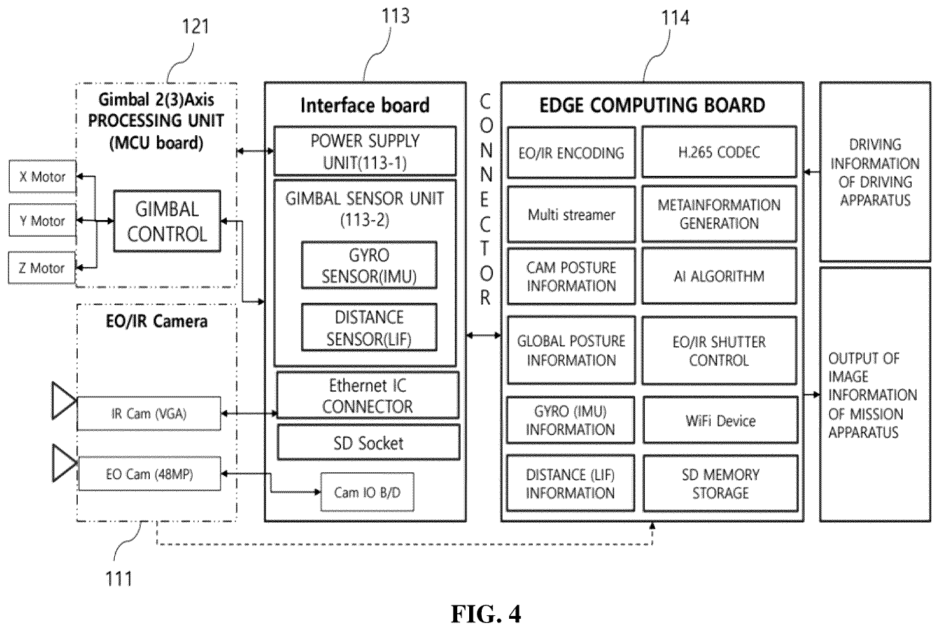

FIG. 4 is a block diagram showing the imaging apparatus of FIG. 1 in detail, wherein the image input/output board 112 is formed between the EO sensor 111-1 and the interface board 113, and performs an image input and output function. The interface board 113 provides an image signal to the edge computing board 114, and provides an interface for image input/output and posture control.

The edge computing board 114 has image processing and object detection functions. The edge computing board 114 includes an image signal processor (ISP) for image processing, and includes an AI algorithm for object detection.

The first case 115 exposes a lens of the image sensor unit 111, and houses each board. The image processing unit 110 is configured such that the edge computing board 114, the interface board 113, and the image input/output board 112 are stacked in the first case 115 in that order so as to have a predetermined size and weight.

In the present invention, since the image processing unit is configured in the above stacking order, the mission apparatus may be manufactured to have a predetermined size and weight, and therefore it is possible to provide a mission apparatus 100 that is smaller and lighter than a conventional apparatus.

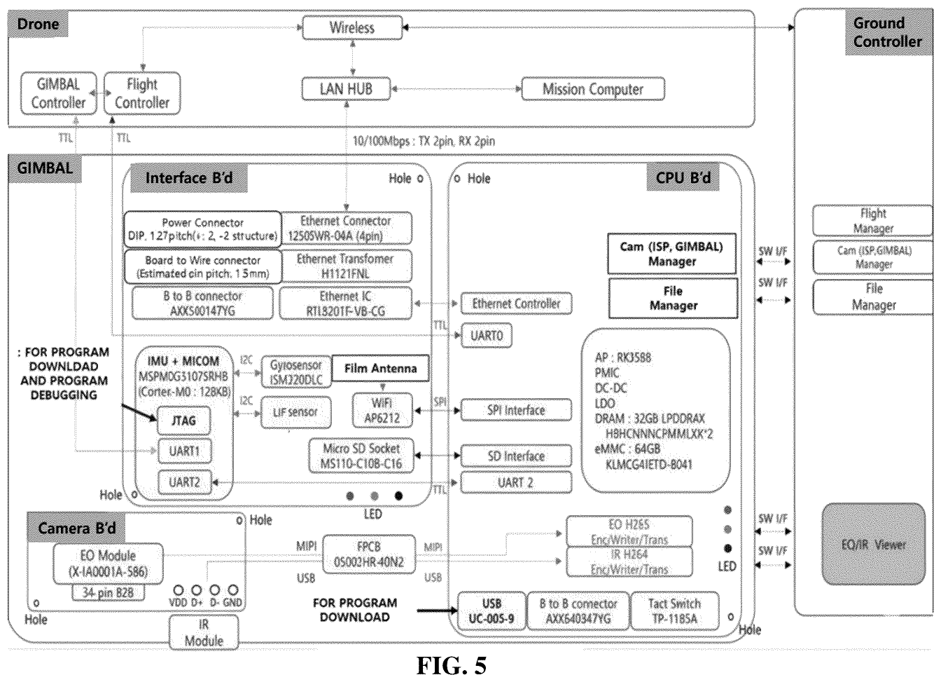

FIG. 5 shows an autonomous flight system using artificial intelligence-based edge computing according to an embodiment of the present invention, wherein the autonomous flight system 10 includes a mission apparatus 100, a drone 200, and a ground controller 300. In the present invention, various driving apparatuses may be adopted, and the driving apparatus is described as a drone 200, but is not limited thereto. The ground controller 300 may be a controller configured to pilot the drone 200 or a ground control station configured to control the drone.

The interface board 113 and the edge computing board 114 will be described in detail with reference to FIGS. 4 and 5. The interface board 113 may include a gimbal sensor unit 113-2, an SD socket 113-3, and a power supply unit 113-1.

The gimbal sensor unit 113-2 may include a gyro sensor 113-2a and a distance sensor 113-2b configured to generate gimbal information. The gyro sensor 113-2a is also called a gyroscope, and has an angular velocity measurement function. The distance sensor 113-2b is also called an inertial measurement unit (IMU), and has velocity, direction, gravity, and acceleration measurement functions. The SD socket 113-3 has a SD memory mounting function, and the power supply unit 113-1 has a function of supplying power necessary to operate each component.

The edge computing board 114 may include an SD interface 114-1, DRAM 114-2, and a codec 114-3. The SD interface 114-1 has a function of reading and writing SD memory, and the DRAM 114-2 is formed adjacent to the SD interface. The codec 114-3 is disposed so as to correspond to the image input/output board 112, is formed under the DRAM 114-2, and processes an image signal according to a predetermined format.

In the present invention, the image input/output board 112 and the codec 114-3 may be disposed within the shortest distance from a period during which an image signal is detected to a period during which the image signal is processed according to the predetermined format, and memory (SD memory and DRAM) may be disposed adjacent to the image input/output board 112 or the codec 114-3, thereby reducing image signal loss and transmission delay.

The edge computing board 114 may detect an image signal to generate video, may generate metainformation using gimbal information about the posture of the edge computing board and driving information about driving of the driving apparatus, and may process the video and the metainformation according to a predetermined format.

The edge computing board 114 may learn the video and the metainformation using an artificial intelligence algorithm to detect an object, and may synchronize the coordinates of the detected object with time to generate metainformation including time coordinates of the object, whereby it is possible to reduce an error related to real-time synchronization of video frames.

High-capacity camera sensors typically suffer from image data loss unless the CPU and memory are disposed at an optimal distance. Therefore, high-capacity camera interfaces require the shortest possible placement distance. For such image processing, an image signal processing (ISP) computer board is constituted as an on-board unit integrated with an interface board, increasing the size thereof. This has conventionally made it difficult to achieve the camera specifications required by drone mission apparatuses.

In order to solve this, in the present invention, the edge computing board 114 for image signal processing (ISP) and the interface board 113 are stacked. Particularly, the placement of the CPU for image signal processing (ISP) and memory utilizes ball grid array (BGA) artwork multilayer optimization to achieve ultra-compact miniaturization under 50 mm, and the placement of connectors and other components under the closest distance conditions enables image signal processing.

Conventional gimbal cameras, weighing 300 g to 500 g or more, employ methods in which data is received from drones and ground control stations for AI processing. In addition, methods supporting AI for human objects have been proposed using low-resolution cameras.

However, conventional approaches have failed to present methods of acquiring coordinates of AI objects and real-time objects from high-resolution cameras and methods of offering techniques for optimizing high-resolution ISP. In other words, conventional methods face the challenge of securing the reliability of ISP signal processing, such as shortest distance noise interference between high-resolution EO sensors and CPUs.

In order to achieve ultra-compact configuration, the present invention is configured such that a metainformation synchronization structure that calculates the orientation and distance of the gimbal posture sensor, the distance sensor, and the camera and such that flight information is received from an external drone to configure the camera posture and the drone posture in real-time using Earth-centered coordinates, thereby calculating metainformation and transmitting the same to an ISP edge computer for precise position calculation.

Particularly, the synchronization of large-scale data and sensor fusion in the present invention employs the shortest distance specification for sensor signals, in which case processing without data signal loss is possible through the ISP edge computer transmission structure, and only the ISP edge computer CPU and memory connectors are configured such that ultra-compact gimbal camera signal processing is possible through the CPU board minimal specifications focused solely on camera mission processing.

In the present invention, therefore, module optimization is achieved by configuring a sensor signal acquisition unit, a CPU board connector, a power supply unit, a network I/O connector, and a SD card as an interface I/O board with no signal loss of the EO/IR sensor, enabling on-board signal processing.

Conventional H.265 codec requires 5 to 6M data transmission for real-time 4K video transmission, and significant data fluctuations based on background scenes cause video stuttering during transmission. Therefore, in the present invention, in addition to the H.265 codec processing results, the drone mission equipment applies the SRT protocol to transmission specifications defined by bit rate and frame rate techniques for the latest video codec including metainformation, thereby applying a high-resolution, low-latency video transmission data signal processing method considering a 2M band.

The royalty-free, open-source video transmission SRT protocol (secure reliable transport protocol), which is a reliable, secure data transmission protocol having a function of automatically optimizing transmission rates based on network conditions through adaptive bandwidth adjustment is applied, whereby a high-quality, low-latency, and secure SRT real-time video optimization method is included in H.265, and therefore application of SRT enables transmission of video at the same quality as existing RTSP using lower bandwidth.

In conventional technology and methods, an image is transmitted from the gimbal camera unit to the drone, and the ground control performs AI processing on the received image. Conventional technology transmits an image using bit rate techniques and frame rate optimization methods due to limited bandwidth, and AI object recognition on the received screen suffers from low identification rates due to the bit rate techniques.

In the present invention, the camera ISP board may clearly recognize an AI object, and when the results are transmitted after optimizing the same using bit rate techniques, frame rate, and the SRT protocol, it is possible to preemptively identify objects not detected in the transmitted image, thereby enabling object recognition.

Human recognition in cameras is expected at approximately 70 to 80 m for HD, at 150 m for FHD, and at approximately 300 m for 4K. However, the image transmitted using bit rate techniques, frame rate, and SRT reduces resolution to optimize data transmission capacity, resulting in blurred screens and decreased AI recognition rates.

Therefore, the AI object recognition of the present invention involves recognizing objects using AI on a clear camera image, transmitting the AI result image to the ground, and enabling the ground station to recognize the identified objects on a screen at a 2-megapixel resolution.

Furthermore, the present invention provides a method of clarifying blurred screens using conventional AI technology by incorporating original training data, bit rate techniques, and frame rate SRT transmission data into subsequent AI learning algorithms such that blurred objects can be restored clearly through AI processing.

Conventional camera image signal processing handles only one limited resolution (e.g., 2 M, 4 M, or 8 M). In the present invention, however, the edge computing board 114 includes four CPUs and four GPUs, enabling simultaneous signal processing of a high-resolution image and a thermal image, and is designed to perform artificial intelligence object recognition through the CPU as needed.

Furthermore, in the present invention, the edge computing board 114 has various versions of an artificial intelligence-trained on-device AI algorithm, and therefore when the operator remotely selects and uploads a multiple object learning algorithm such as for human objects or humans and vehicles, it is possible to recognize multiple objects.

Furthermore, image transmission includes time-synchronized metainformation with the real-time image, which allows users to perform object recognition required by the drone or the ground control for different objects, and therefore the concept of multiple objects may be utilized both as a method to distinguish and recognize various types of objects and as a concept enabling object recognition at the transmitted position for each object.

Referring back to FIG. 3, the posture adjustment unit 130 may include an X-axis adjustment means 131 configured to adjust the X-axis shooting direction, a Y-axis adjustment means 132 configured to adjust the Y-axis shooting direction, a Z-axis adjustment means 133 configured to adjust the Z-axis shooting direction, and a connection member 134 configured to connect the axes to each other.

The X-axis adjustment means 131 includes an X-axis motor 131-1 disposed on one side of the first case 115 adjacent to the EO sensor 111-1 and an X-axis bearing 131-2 disposed on the other side of the first case 115 adjacent to the IR sensor 111-2.

The X-axis adjustment means is disposed at a predetermined position on the image processing unit 110, considering the weight relationship between the EO sensor 111-1 and the IR sensor 111-2 and the structure of the stacked board, and the X-axis motor 131-1 may be operated with a predetermined torque.

The EO sensor 111-1 is lighter than the IR sensor 111-2. In the present invention, therefore, the X-axis motor 131-1, which is heavier than the X-axis bearing 131-2, is disposed on one side of the first case 115 adjacent to the EO sensor 111-1, which significantly contributes to the miniaturization and weight reduction of the mission apparatus 100. Furthermore, in the present invention, since the X-axis adjustment means 131 is located on the stacked side of the boards, it is possible to provide a stable coupling and arrangement structure.

Furthermore, conventional gimbals use an encoder and a limit switch on a motor for X-axis positioning. In the present invention, however, it is possible to contribute to miniaturization and weight reduction by controlling the X-axis motor 131-1 weighing less than 10 g without the need for a control cable using a BLDC motor as the IMU posture control method for weight reduction of the X-axis adjustment means and simply performing posture processing through power signal control based on the posture. For reference, the Y-axis requires over twice the load of the X-axis, and therefore the same is configured as a BLDC motor weighing approximately 20 g.

The posture control unit 120 may include a gimbal board 121 and a second case 122. The gimbal board 121 may control the operation of the posture adjustment unit 120 using gimbal information. The second case 122 may house the gimbal board, including the Z-axis adjustment means formed under the gimbal board.

The Y-axis adjustment means 132 may be formed between the first case 115 and the connection member 134, and the Z-axis adjustment means 133 may be formed between the second case 122 and the connection member 134. The connection member 134 may have a function of providing communication between the image processing unit 110 and the posture control unit 120 or supplying power to the posture control unit 120.

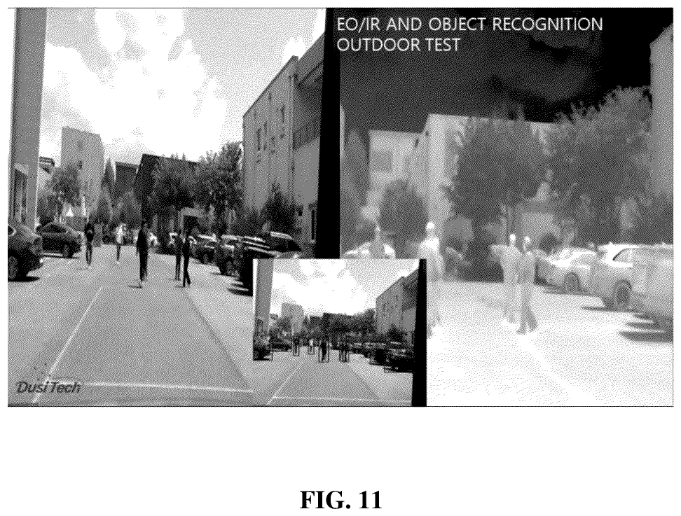

In the present invention, balance between the posture control unit 120 and the image processing unit 110 may be maintained through the connection member 134, and transmission delay may be reduced by the technique for disposing each unit. A detailed description thereof will be given later with reference to FIG. 11.

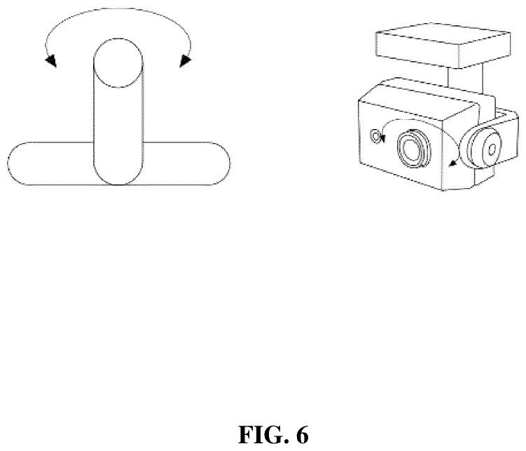

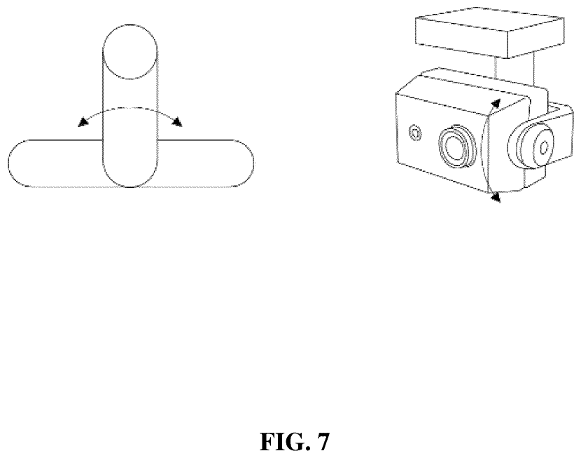

FIG. 6 is an example of adjusting a roll angle of the mission apparatus, and FIG. 7 is an example of adjusting a pitch angle of the mission apparatus. In the present invention, the roll angle may be adjusted using a stick of the controller, and the pitch angle may be adjusted using the stick of the controller. The motors of each axis may be manipulated through such manual operation through the controller to set the precise viewing position of the camera.

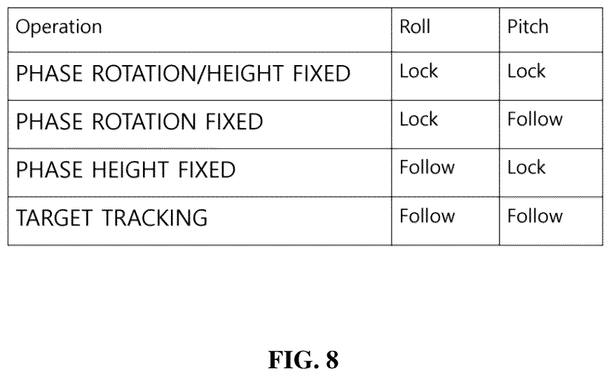

FIG. 8 is an example illustrating the operation for automatically aligning the angle of the mission apparatus. In the present invention, when power is applied to the dual image sensor unit 111, an automatic mode for initial alignment may be performed, enabling the calculation of the precise position viewed by the image sensor unit 111.

For example, in the present invention, when the automatic mode of the mission apparatus 100 is activated, the value of each axis input to the posture control unit 120 is input, when a follow signal is input, the target angle of the motor is changed in real time, and when a lock signal is input, the target angle is locked and the automatic mode for initial alignment is performed while waiting for the follow signal.

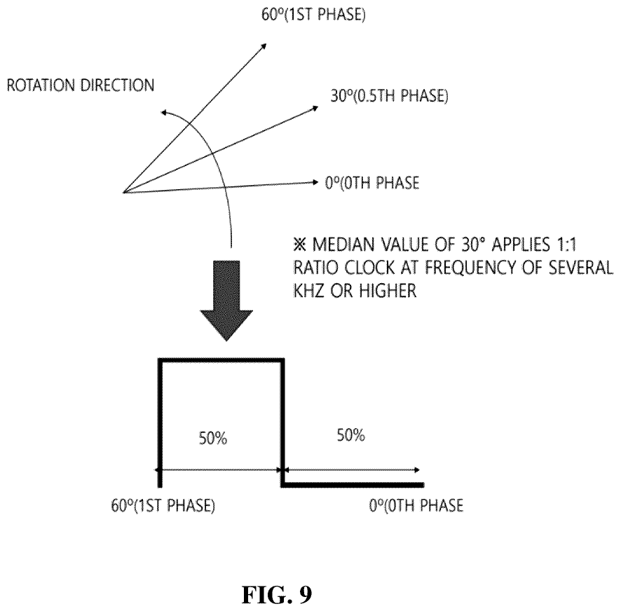

FIG. 9 is an example of controlling a BLDC motor according to posture control based on viewing angles of dual cameras, wherein the dual cameras refer to the EO sensor 111-1 and IR sensor 111-2, and the BLDC motor refers to an adjustment means of the posture adjustment unit 130.

In the present invention, a BLDC ultra-fine angle drive algorithm may be applied to BLDC posture control. The ultra-fine angle algorithm is a method that smoothly controls the BLDC motor according to posture control, based on the optimal center value of the dual camera, to adjust the viewing angle of the camera.

For example, the ultra-fine angle algorithm applies a clock signal to two phase signals at a ratio corresponding to the target angle. While the rotor position is difficult to determine, this is overcome through rapid control. As precision increases, response speed delays occur; therefore, the ultra-fine angle algorithm is an optimal method of performing PID control.

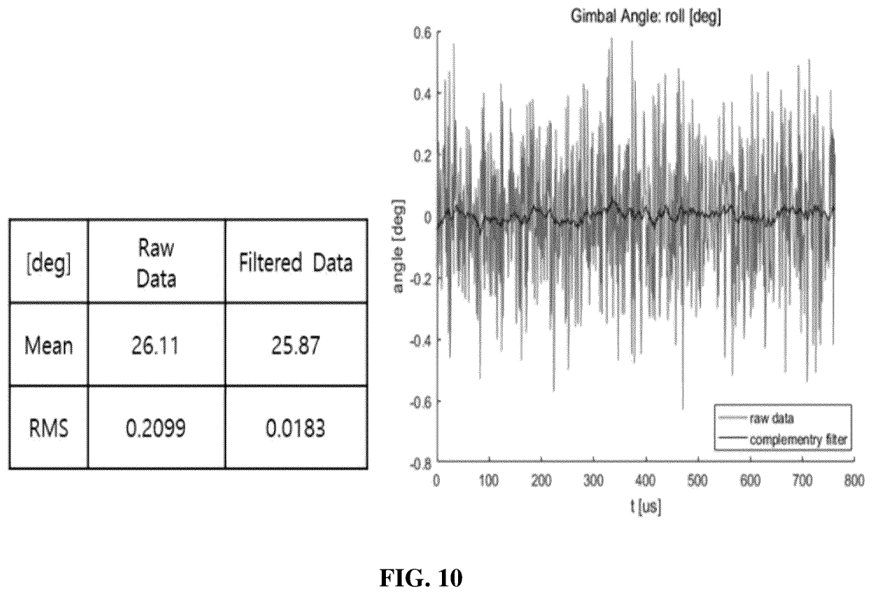

FIG. 10 is an example of filtering raw data of the posture sensor, wherein the IMU posture sensor may be the distance sensor 113-2b. In the present invention, a complementary filter may be applied to the posture sensor information, whereby it is possible to provide stabilization of the control angle and to implement smoother posture control of MEMS IMU than a conventional encoder PID.

Technology that combines the advantages of a gyroscope in a high-frequency range and the advantages of an accelerometer in a low-frequency range is applied to the complementary filter. Conventional methods pertain to PID control angle maintenance based on XYZ-axis encoder pulse counter positions, requiring various signal processing steps such as start angle and end angle limit sensors.

However, the present invention relates to a precision control method for maintaining the angle of an IMU posture sensor facing the camera, wherein signal processing may be simplified by controlling the posture sensor angle maintenance based on the movement of the drone, and it is possible to reduce angle error by 91% in high-speed configurations, such as RMS to raw data, in 763 samples, as shown in FIG. 10.

FIG. 11 is an example of an object recognition experiment utilizing the mission apparatus of the present invention, wherein the mission apparatus 100 mounted on the drone of the present invention may acquire real-time video from the view of the high-resolution EO/IR camera during high-speed flight through the image signal processing (ISP) software.

Furthermore, the mission apparatus 100 may acquire raw data, such as metainformation, from an image obtained by image signal processing a plurality of extracted objects using a pre-trained AI object identification algorithm on the edge computing board 114 and flight information received from the distance sensor, such as the IMU posture sensor, and the drone.

The edge computing board 114 may convert the data into global coordinate standard posture values, generate H.264 video and metainformation in a container, configure frames according to a low-capacity MPEG format under 2 M, and transmit the same to the drone.

Since the H.265 latest codec video includes artificial intelligence-trained object recognition metainformation, the edge computing board 114 may process the position and time information determined by synchronizing identified object-specific position coordinates with the time coordinates of objects calculated as the metainformation.

In the present invention, it is possible to acquire metainformation synchronizing objects and time coordinates in real-time, to recognize objects using pre-learned artificial intelligence algorithms, and to process the time coordinates of video digital information in video and metainformation frames without loss.

Furthermore, in the present invention, it is possible to display the camera's viewing angle, to represent video in real-time coordinates, to calculate object identification and object coordinates learned through video and metainformation through MPEG, to output the results, thereby providing an artificial intelligence service. The prior art will hereinafter be described for comparison.

Patent Document 2 is similar to a drone equipped with an onboard flight control computer and a drone camera video object position coordinate acquisition system using the same. However, the conventional method is a method of receiving an image of a mission apparatus from the drone, acquiring an image and metainformation, synchronizing the time, and transmitting the same to the ground. However, the present invention may solve problems of image transmission delay and lower quality by implementing a system that performs AI object and coordinate acquisition in real-time directly by the mission apparatus without processing by the drone or transmits video and metainformation to be processed on the ground.

Furthermore, Patent Document 2 uses a low-resolution video codec and requires a wide frequency band of 10 Mbps for data transmission. In the present invention, however, the latest codec processing technology enabling transmission of EO/IR dual images at 2 Mbps is applied to 4K video.

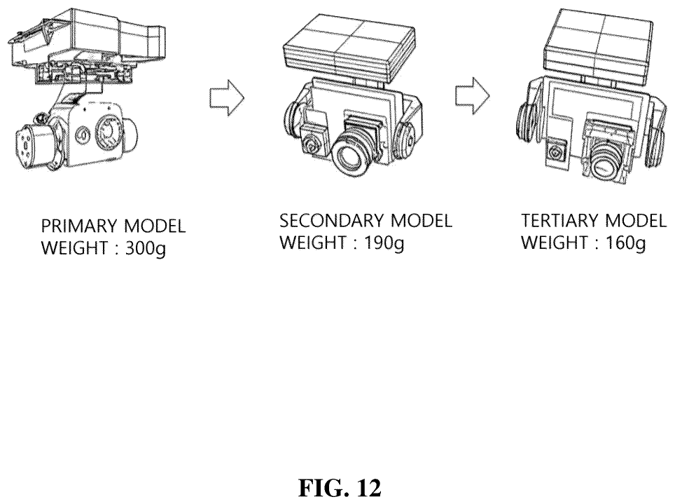

FIG. 12 is an example showing a primary model to a tertiary model of the mission apparatus, wherein the features of the present invention will be described in detail by comparing models developed directly by the applicant.

The primary model was developed in-house. At the time of development, 300 g EO/IR camera module products were uncommon technology. During the development of the primary model, we experienced that transmitting the camera's 8-megapixel 4K raw data caused severe noise effects depending on the data transmission volume. In order to optimize the correlation between the center of gravity and the motor drive torque, we conducted extensive research on sensor signal processing centered on interfaces to minimize EO/IR materials, the ISP signal processing, and cable handling from the material development stage in order to achieve optimal configurations for ISP signal processing and the optimal distance placement of the EO camera.

In the primary model, all boards were disposed on top of the camera. While the boards did not have AI or image processing hardware at this stage, this arrangement required an axis conversion mechanism between the camera and board, potentially increasing data loss due to longer signal paths.

In order to solve the problems, a secondary model was developed. A new stacked structure was applied to the secondary model to solve the problems of the primary model, enabling the development of a compact, lightweight mission apparatus.

The difference between the second and tertiary models lies in the lens processing technology. In the secondary model, a 14 mm lightweight lens was applied to the IR sensor, and in the tertiary model, an ultra-lightweight lens was applied to the IR sensor. In the present invention, therefore, it was possible to align the center of gravity of the mission apparatus 100 by applying the ultra-lightweight lens.

More specifically, the positions of the EO camera module differ slightly between the second and tertiary models, and the LIF sensor and the overall Y-axis center of gravity are aligned in the tertiary model.

When the secondary model was configured, the weight of the X-axis motor was approximately 10 g, and the weight of the IR sensor module was about 65 g even when the EO camera module was disposed, which caused problems with increased motor load on the Y-axis and weight reduction challenges.

In the tertiary model, therefore, the X-axis and Y-axis centers of gravity were optimized by reducing the weight of the glass lens of the IR sensor, and the motor and bearing structure was precisely applied in order to lower the torque value of rotational motion.

Accordingly, in the tertiary model, the weight of the glass lens of the IR sensor was reduced using a plastic material, and the weight of the IR sensor was optimized to 40 g by disposing a guide configured to fix the IR lens and an IR sensor board, whereby the XY driving torque load was optimized through the precise placement of the X axis and the Y axis, and an optimized placement configuration of approximately 160 g (3% error) was achieved.

Furthermore, in the tertiary model, the number of electric wires was reduced by using a connector socket method instead of using a connection cable such as a block diagram, power and data were simultaneously supplied to the interface board 113 and the upper posture control unit 120 via serial transmission, and heat dissipation from the edge computing board 114 was addressed by applying a dual-injection aluminum structure to the camera mechanism for direct contact between the CPU and the aluminum heat sink of the housing.

For reference, conventional overseas commercial gimbals for drones with 12 MP or higher resolution employ methods to place shielded cables within 60 mm to prevent MIPI image data loss from EO cameras, which is why ultra-compact high-resolution cameras become smaller, and ultra-lightweight shielded cables or dedicated FPCBs are manufactured to transmit raw image signals to the ISP board. For example, the ultra-compact gimbal structures of Chinese models like the Phantom and Mavic employ a high-resolution EO MIPI signal-optimized, compact lightweight structure where ISP is performed on the top of the gimbal.

In addition, conventional camera gimbals employed either a global shutter camera with a high-performance lens, resulting in high weight but high sharpness, or a low-resolution 2-axis fixed configuration where the camera and ISP were optimally located using a single-channel ISP board. In particular, conventional EO/IR image signal processing typically involved equipping each with its own ISP signal processing and transmitting images to the drone via a dual-channel system.

In the present invention, however, a method of integrating and receiving the EO sensor MIPI raw data and IR RAW data directly from the ISP edge computer, a method of optimally configuring the EO sensor and ultra-compact signal processing board as an interface board with the CPU to prevent loss of 48 MP EO data and estimating the camera's viewing position by linking with an IMU+LIF sensor, and a method of processing on-device AI through signal synchronization during the image acquisition stage are applied.

In conventional EO/IR camera gimbal structures, transmitting the EO camera's 8-megapixel MIPI data was possible without data signal loss even over long data transmission buses, enabling the transmission of raw image data, and starting from 12MP EO cameras, the increased data capacity of the EO sensor means that, for MIPI signals, when transmitting raw image data over distances exceeding 60 mm, significant noise loss occurs unless sufficiently large, high-quality shielding materials are used. Therefore, for extremely high-resolution raw image data like the proposed 48MP, the camera MIPI sensor and CPU must be placed within a distance of 30 mm.

Therefore, the primary model was manufactured using an 8 MP (megapixel) camera with an FPCB, but image MIPI data transmission acquisition errors occurred due to the approximately 10 cm data bus length. For reference, conventional technology employs an oversized ISP signal processing board to process EO/IR camera raw data on the top of the gimbal, which a method used in most overseas products.

In contrast, in the second and tertiary models, the shortest-distance interface design without loss of high-resolution EO/IR raw data and the ultra-compact edge computer capable of ISP and AI processing using the latest high-resolution codec were applied, thereby providing stable signal processing suitable for drone camera mission equipment, including optimal placement of EO/IR sensors and ISP, for which no commercial products currently exist.

Image signal processing by large-capacity camera sensors like 48 mp sensors exhibits significant data loss as distance from the CPU increases, and therefore the technology must be implemented through the closest possible component placement. In the present invention, therefore, 48 mp EO, VGA IR, sensor placement, and ISP signal processing were fused to achieve an ultra-compact on-board implementation under 50 mm.

In the present invention, shutter control is applied by processing metainformation in a state of being temporally synchronized with the image frame viewed by the camera, which may minimize positional accuracy or transmission errors more effectively than conventional acquisition methods using drones.

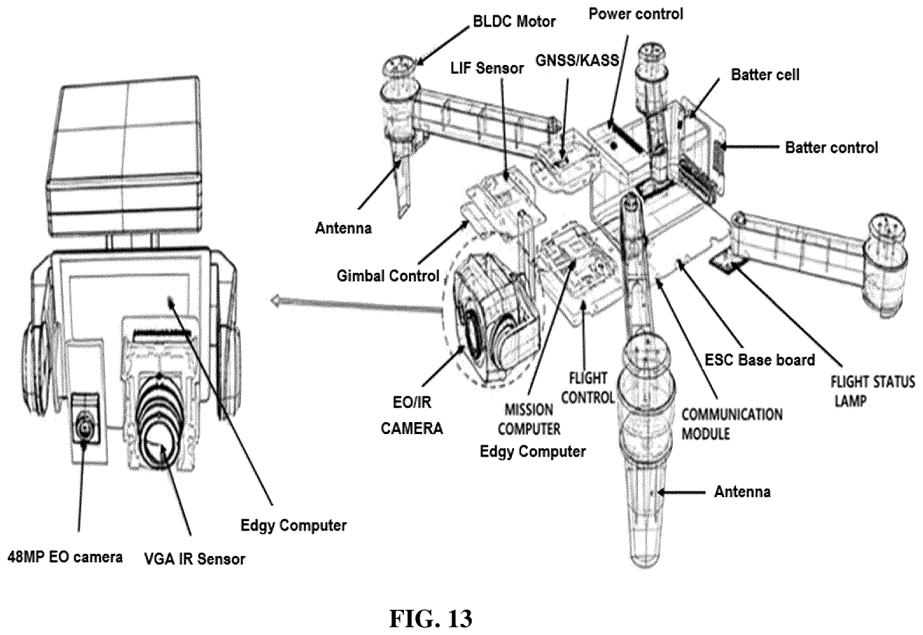

FIG. 13 shows an example in which the mission apparatus of FIG. 1 is coupled to a drone, wherein the mission apparatus 100 may be coupled to a driving apparatus. The driving apparatus may be a tank or a ship, or, as shown in FIG. 13, a drone 200. Hereinafter, the driving apparatus will be described as the drone 200; however, the present invention is not limited thereto.

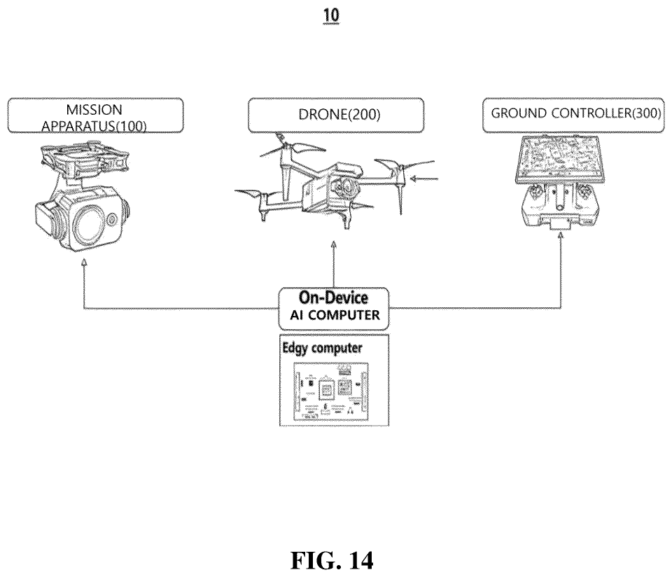

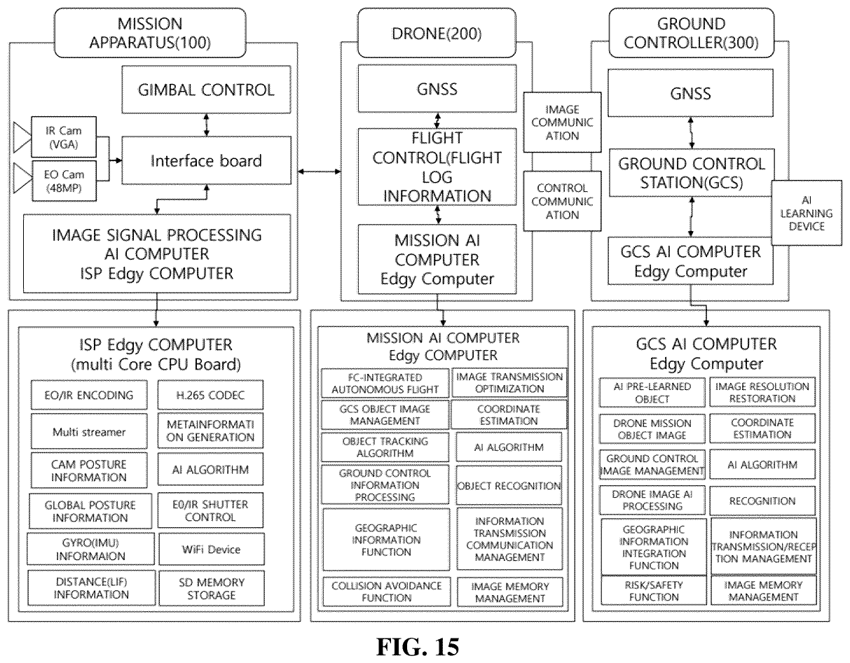

FIG. 14 shows an autonomous flight system using artificial intelligence-based edge computing according to another embodiment of the present invention, and FIG. 15 shows an autonomous flight system using artificial intelligence-based edge computing according to yet another embodiment of the present invention.

The autonomous flight system 10 includes a mission apparatus 100, a drone 200, and a ground controller 300. The mission apparatus 100, the drone 200, and the ground controller 300 perform object detection or tracking using artificial intelligence-based edge computing.

The ground controller 300 is an apparatus that provides control commands to the drone 200 or controls the drone. The ground controller 300 may include a controller, a ground control station, a ground control system (GCS), a geographic information system (GIS), and a global navigation satellite system (GNSS).

The mission apparatus 100 detects an image signal to generate video, generates metainformation using gimbal information about the posture of the mission apparatus and flight information of the drone, learns the video and the metainformation to detect an object, and temporally synchronizes the coordinates of the detected object to generate metainformation including time coordinates of the object.

The drone 200 applies a predetermined format and specifications to the metainformation and the video to generate low-capacity data, and transmits the low-capacity data to the ground controller 300 within a limited frequency band.

The ground controller 300 restores the video utilizing the format and the specifications applied to the low-capacity data, recognizes an object pre-learned by the mission apparatus utilizing the metainformation, when a specific object is designated, enhances the resolution of an image including the specific object to generate a designated image, and provides the designated image to the drone for real-time tracking of the specific object.

The mission apparatus 100 may directly process the image and the metainformation to reduce image signal loss or transmission delay, and may detect an object in advance to increase the accuracy of object recognition at the ground controller 300.

The drone 200 may provide low-capacity data to which a predetermined format and specifications are applied to the ground controller 300, thereby reducing transmission delay or video stuttering within a limited bandwidth.

The ground controller 300 may transmit the designated image to the drone 200 within a predetermined time by restoring the video and recognizing the pre-learned object.

When the specific object is designated, the ground controller 300 may learn the feature points of the pre-learned object to search for the specific object, may enhance the resolution of an image including the searched specific object to generate a designated image, and may provide information regarding the coordinates of the specific object and the designated image to the drone 200.

The drone 200 may track the specific object utilizing the coordinates of the specific object and the designated image provided by the ground controller 300, and if the specific object moves during the autonomous flight tracking process, may fuse metainformation acquired during the tracking process with the image of the mission apparatus.

In the present invention, the drone 200 may determine precise positions in real-time through the image, and may recognize and track objects through autonomous flight using artificial intelligence. Furthermore, in the present invention, the image of the mission apparatus 100 and the metainformation are synchronized to obtain precise positions, and the drone is equipped with an ultra-compact edge computer to search for and track objects in real-time while controlling flight. The ground controller 300 may command the drone 200 to search for objects through the received image or track objects designated by the operator, and may control the drone 200 to perform surveillance and reconnaissance missions through autonomous flight.

The mission apparatus 100 uses a high-resolution camera and an EO/IR (electro-optical/infrared) sensor capable of day and night image acquisition to perform precise position calculation and object recognition even during high-speed flight.

In the present invention, an artificial intelligence computer, a global navigation satellite system (GNSS), and a flight control system (FC) may be mounted onto the body of a small drone 200 weighing 1 to 1.6 kg, and the small artificial intelligence drone 200 may track objects in real-time and perform autonomous flight.

The drone 200 may process large-capacity 48-megapixel image signals and may perform image processing through dual processing of 4K video and VGA thermal image sensors to generate a high-resolution image, and may transmits the image to the ground controller 300 within a limited 2 Mbps wireless communication bandwidth.

The transmitted image is restored clearly through an AI algorithm, enabling the AI drone to autonomously fly to track the object designated by the operator in real time.

Specifically, the present invention may relate to ultra-compact camera gimbal technology that enables a day/night camera mounted on the drone to perform precise positioning, object recognition, search, and movement tracking.

The mission apparatus 100 may synchronize position information, camera angle, and metainformation such as posture, angle, and altitude of the mission apparatus and the drone 200 with the image frame acquisition time from the camera and image signal processing board, enabling the transmission of more accurate data to the drone 200.

The drone 200 is equipped with an ultra-compact on-board artificial intelligence-based computer capable of on-device artificial intelligence (AI), the 4K video acquired by the mission apparatus 100 may be transmitted to the ground controller 300 as a large image consisting of 5 to 6 megapixel high-resolution video, a thermal image, and metainformation within a limited 2 Mbps wireless communication frequency band. The ground controller 300 may restore the same.

During this process, the drone 200 may optimize bit rate techniques and frame rate transmission specification using the SRT protocol for transmission.

In addition, the drone 200 may use a container format that fuses the metainformation and the image acquired during flight and converts the same into global coordinates, and may calculate the position of an object more precisely than existing methods based on data synchronized with the camera video acquisition time, whereby it is possible to perform tracking through rapid flight control integration when the object moves.

The drone 200 may have safety scenarios such as obstacle avoidance, communication failure handling, and automatic return in case of low battery, and may transmit the mission status to the ground controller 300 in real time during autonomous flight.

The ground controller 300 may clearly restore the received blurred 2 Mbps image through the edge computer using an AI algorithm, may calculate image coordinates from metainformation in the acquired image, and may recognize the pre-learned objects in the image.

In addition, the ground controller 300 and the drone 200 have a function of designating a specific object or, when a pre-learned object is selected, recognizing the object in the image. The object designated by the ground controller 300 may be transmitted to the drone 200, and the drone 200 may track the same in real time or track the object through autonomous flight within a designated area.

The present invention relates to a system configured such that a small AI drone 200 can search for objects day and night, track the same in real time, acquire and transmit precise coordinates of the objects, and perform autonomous flight under the control and with the authorization of an operator.

The autonomous flight method involves the drone flying autonomously within a predefined flight area based on learned object recognition, and when necessary, flight authorization may be received from the operator to perform tasks.

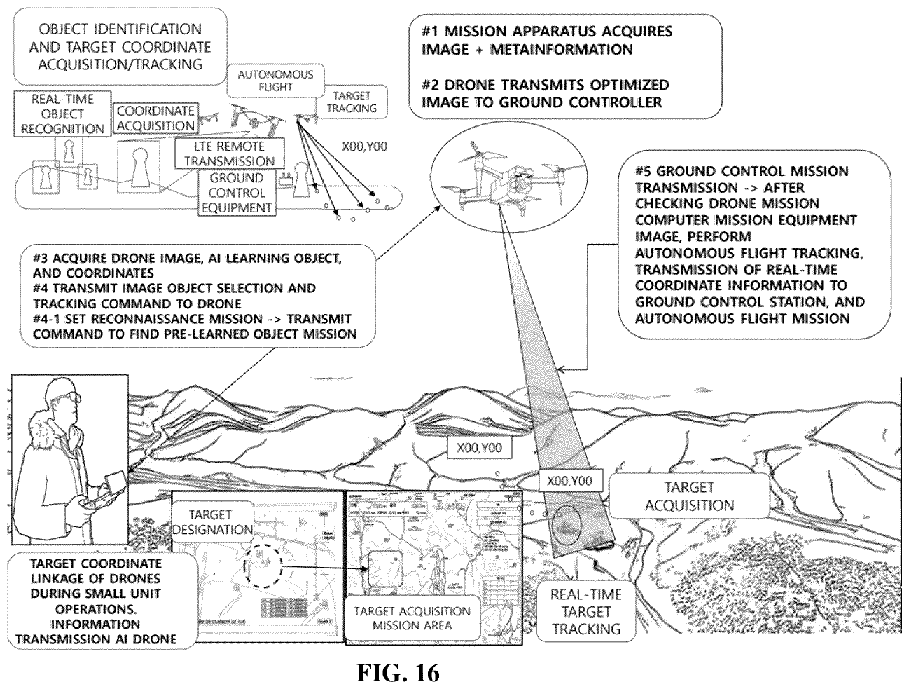

FIG. 16 is an example showing an operational overview of the autonomous flight system using artificial intelligence-based edge computing according to the present invention, wherein the mission apparatus 100 has image processing and object detection functions, and metainformation may be acquired through the functions. The drone 200 may apply image optimization to provide low-capacity data to the ground controller 300 within a limited frequency band.

The ground controller 300 may generate a tracking command for a specific object based on the image of the mission apparatus 100, and may transmit the coordinates and the image of the specific object to the drone based on the tracking command. At this time, the image is a high-quality image processed through image processing. Since the drone 200 sends all images, low-capacity image optimization is necessary, and since the ground controller 300 transmits only a specific image to the drone 200, high-quality image processing is necessary.

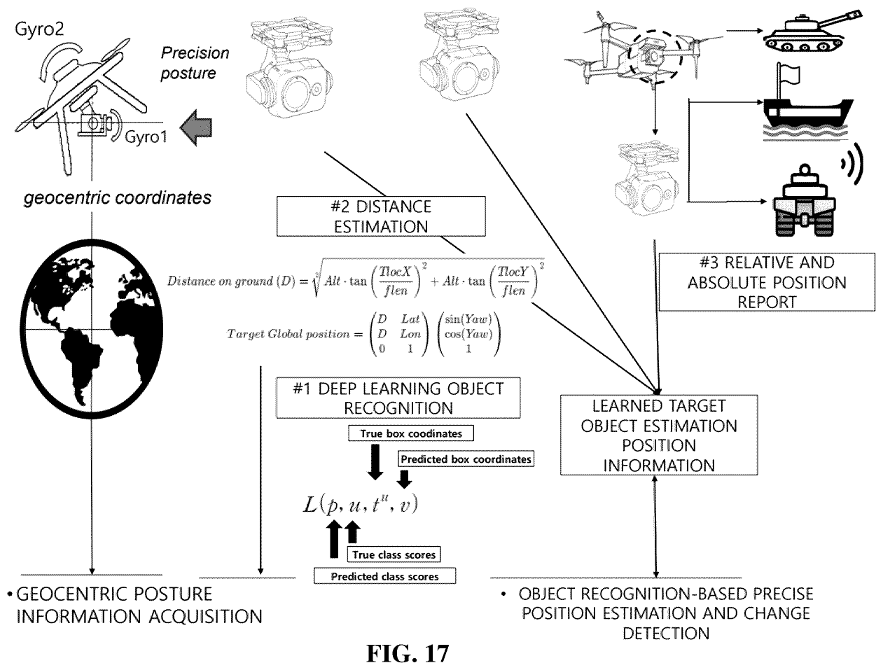

FIG. 17 is an example showing the mission apparatus to which an artificial intelligence algorithm for distance estimation and object recognition is applied, wherein the mission apparatus 100 recognizes a deep learning object, estimates the distance, and reports relative and absolute positions. Here, deep learning object recognition is expressed by Equation 1.

$$L ( p , u , {t}^{u ,} v ) \qquad \{ Equation 1 ]$$

Here, deep learning object recognition L is the loss, p is the predicted class scores, u is the true class scores, tu is the true box coordinates, and v is the predicted box coordinates. This equation signifies learning to minimize the difference between the actual position and the estimated position. Distance estimation is expressed by Equation 2.

$$Distance on ground ( D ) = \sqrt[2]{Alt * {tan ( \frac{TlocX}{flen} )}^{2} + Alt * tan {( \frac{TlocY}{flen} )}^{2}} \qquad [ Equation 2 ]$$

$$Target Global position = ( \begin{matrix}D & Lat \\ D & Lon \\ 0 & 1\end{matrix} ) ( \begin{matrix}sin ( Yaw ) \\ cos ( Yaw ) \\ 1\end{matrix} )$$

Here, distance on ground (D) is the ground-based target distance measurement, and target global position is the object recognition position coordinates. Relative absolute position reporting involves detecting changes in the precise position estimation based on object recognition.

In drone operations, multi-drone autonomous flight faces the issue of excessive frequency occupancy even at low resolutions during video transmission. In order to address this, if frequency occupancy can be reduced at high resolutions, the drone 200 may be delegated flight control authority from the operator during flight, and may automatically search for object types pre-designated by the ground control operator while transmitting flight information to the ground controller 300 in the state in which only the mission purpose and control range are set.

Furthermore, if the flight operator designates an object requiring movement tracking in the real-time video, the drone 200 may automatically perform the mission of tracking the object. When the drone 200 presets an area to be searched through autonomous flight, it is possible to implement a system in which the drone independently tracks objects or conducts autonomous exploration. This may enable rapid search of large areas, and 1 to 3 AI drones may have functions of autonomously searching for designated objects within respective areas and transmitting real-time information or performing tracking.

Frequencies may be allocated to drones in 2 MHz increments by frequency hopping using a band of approximately 85 MHz based on unlicensed low-power radio communication, and a multi-frequency operating system may be configured so as to integrate drone image operations on clean frequencies. This enables 1 to 3 AI drones to simultaneously operate across a wide search area while performing autonomous flight and real-time video transmission and to effectively execute object recognition and coordinate search.

In order to solve the problem of freely exchanging autonomous flight authority among drones while performing missions, camera resolution and metainformation may provide the precise position, and the movement time of the tracked image may be estimated based on synchronization between the image and the time. A method of transmitting the image and the metainformation to the autonomous flight AI drone boy and the ground control smart controller and delegating operator control and autonomous flight mission authority to the AI drone body, a method of configuring a system that achieves mission purpose through real-time information of the drone body, and a physical method for information transmission are required.

The higher the video resolution of the mission apparatus, the faster various objects can be located at high altitudes, and the wireless transmission environment from the drone to the operator must provide high resolution within a limited frequency band. To this end, the image optimized by the SRT protocol according to artificial intelligence, the latest H.265 codec, bit rate techniques, and frame rate specifications may be transmitted to the ground control edge computer. Transmission and reception techniques of restoring the bit rate and the frame rate having reduced resolution utilizing an AI learning algorithm may be applied.

This method simultaneously transmits two EO/IR images within a 2 MHz frequency band, enabling smooth wireless communication between a large number of drones within a limited frequency range.

The ultra-lightweight artificial intelligence drone of the present invention has the following technical features in high-resolution image processing and autonomous flight systems.

### <High-Resolution Image Transmission>

A method of transmitting 48-megapixel photos and 4K day/night EO/IR videos at a bandwidth of 2 Mbps or less has been proposed. This method efficiently conveys information while minimizing bandwidth and power consumption during high-resolution image transmission.

When high-resolution video requires a bandwidth of 5 to 6 Mbps, it is possible to enhance compression efficiency and to reduce transmission data volume using the latest codec (H.265/HEVC). However, video stuttering due to communication load may still occur. In order to address this, the bit rate and the frame rate must be optimized, and the frame flow must be maintained smooth through the time synchronization function.

### <High-Performance Computer Installation>

For autonomous flight, the drone is equipped with onboard multi-CPU computers including high-performance CPUs and GPUs, such as artificial intelligence drone body and the ground control equipment, for rapid signal processing from the drone footage, and lightweight edge computers designed for ultra-compact drones are manufactured such that the drone can perform artificial intelligence object tracking and autonomous flight.

This allows the drone to operate as an intelligent drone system with ground control and autonomous flight functions while reducing the weight thereof to approximately 1 to 1.6 kilograms. The onboard flight control computer mounted in the drone and the edge computer in the ground control system synchronize video and metainformation with time, which enables integration with ground geographic information systems to perform object recognition and acquire position coordinates, accurately displaying the actual position coordinates at the time the object was detected in the video.

### <Precision Position and Posture Estimation>

It is possible to minimize potential posture errors during flight using the high-resolution camera, the GPS, the IMU, and the geomagnetic sensors of the drone. The position information of the drone may have SBAS and RTK functions of correcting GNSS, and accurate position and posture may be maintained through precise altitude and sub-centimeter position correction.

MPEG video transmitted from the mission apparatus may include additional metainformation, and the metainformation may be synchronized with the camera viewpoint of the drone. The onboard computer of the smart controller decodes this information, and the ground control system (GCS) analyzes the video and the metainformation to provide precise position coordinates and time information.

Furthermore, it is possible to precisely estimate the movement path and time information of the object by interpreting the high-resolution image captured by the camera of the drone and the position estimation metainformation from object tracking and time-based position information. This is useful, for example, for accurately tracking the movement paths of vehicles or people.

### <Time Synchronization and Image Quality Maintenance>

The video frames received from the drone are synchronized with precise time information, enabling clear recording of the time information of the image. This allows the drone operator to check the timestamp of the image in real time, thereby enhancing object identification accuracy.

Furthermore, when transmitting high-resolution video to ground control system, the latest codec and bit rate techniques may ensure precise synchronization of the frame rate and the time information. This ensures uninterrupted image frames and maintains frames synchronized at precise times, enabling the drone operator to identify an object in real-time and issue a tracking command.

### <Communication Optimization>

Frequencies are allocated using a method similar to frequency hopping such that a plurality of drones can smoothly communicate with each other within a limited narrow frequency band of 2 MHz, and images transmitted by the respective drones are integrated, allowing efficient ground control.

This method may prevent video quality degradation and support simultaneous multi-flight missions across wide search areas. This technical approach enhances drone autonomous flight and object tracking performance and enables efficient data transmission and communication while maintaining image quality. The detailed features of the present invention are as follows.

The mission apparatus 100, the body of the autonomous flight AI drone 200, and the ground controller 300 each are equipped with an on-device AI computer, which may have modes such as high-resolution dual images of the mission apparatus 100, metainformation, MPEG, and object recognition, and may provide mission information in real time during flight of the drone 200.

The body of the autonomous flight AI drone 200 is equipped with an on-device AI computer and has a function of transmitting the high-resolution dual image, the MPEG metainformation, and object recognition information from the mission apparatus 100. Furthermore, when the target of a real-time image instructed by the ground controller 300 is designated, the drone 200 may acquire object information and coordinates to track the target, locate the object trained through self-learning of feature points, receive commands for target acquisition within a mission area, and search for pre-learned object types.

In order to track or search for the designated target, the on-device AI computer of the AI drone 200 may take control of the flight controller (FC) from the smart controller to autonomously track or search for the object.

The ground controller 300, such as the ground control smart controller, may be equipped with an on-device AI computer, and may recognize the object using the on-device AI computer or receive object recognition information from the mission apparatus 100 through settings.

In the present invention, when the target object for tracking is designated, a screen displaying the object having the designated target may be transmitted to the on-device AI computer of the AI drone 200 such that object tracking is performed through autonomous flight and real-time coordinates of the object can be transmitted to the ground control station.

The ground controller 300 may set the type of object to be searched for in advance, search for the object using the on-device AI computer of the AI drone 200 through autonomous flight in the mission area for target acquisition according to automatic flight, and send an alarm to the ground controller 300.

The on-device AI pre-learning function may enable the small AI drone to recognize objects designated by the operator, such as people, cars, tanks/armored vehicles/field artillery, specific objects, and regular inspection hazard recognition.

The autonomous flight AI drone system for real-time tracking may receive an image from the drone 200 having the function of searching for pre-learned on-device AI objects in the mission apparatus 100 during the flight of the drone 200 and transmit 5 to 6 megabyte 4K video through a low band communication of 2 M as an image optimized using bit rate techniques and transmission specifications of fixed frame rate according to the SRT protocol to the ground controller 300, whereby it is possible to clearly restore the bit rate techniques and the frame rate having the reduced resolution using the AI learning algorithm.

The on-device AI object recognition image or the high-resolution dual image and metainformation MPEG of the mission apparatus 100 may be received based on user setting of the mission apparatus 100, and the object and coordinates for image acquisition AI learning of the drone 200 may be acquired.

The ground controller 300 may select missions for pre-learned object types and configure missions by choosing the target acquisition area and reconnaissance object type.

The drone 200 may transmit real-time information and an alarm while performing missions through autonomous flight using the on-device AI computer, and when the ground controller 300 designates an object requiring automatic tracking from the pre-learned objects in the mission apparatus 100, the on-device AI computer of the AI drone may learn the image of the object while automatically tracking and transmit real-time target coordinates to the ground controller 300.

The on-device AI computer of the AI drone 200 is assigned an object tracking mission by the ground controller 300, and recognizes the object in real time and acquire coordinates from the image received from the mission apparatus 100. If the object moves, the on-device AI computer of the AI drone 200 remotely controls the flight controller, tracks the object through autonomous flight, and transmits the search results in real-time to the ground controller 300.

### INDUSTRIAL APPLICABILITY

The present invention has the advantage that artificial intelligence-based edge computing is applied to a drone system, whereby image data and metainformation are processed in a mission apparatus in real time and low-capacity, high-efficiency data transmission is possible. Consequently, the present invention may be directly applied to various industries, including military and civilian drones, autonomous aircraft, various unmanned vehicles, automated surveillance in industrial sites, and disaster, safety, and environmental monitoring. In particular, it is possible to improve accuracy and reliability of object detection and tracking in a limited wireless bandwidth environment, thereby achieving significant ripple effects across multiple fields requiring efficient collaboration and data sharing, such as swarm flight, smart factories, logistics, and border surveillance.

1. An autonomous flight system using artificial intelligence-based edge computing, the autonomous flight system comprising:
a mission apparatus (100) configured to detect an image signal to generate video, to generate metainformation using gimbal information about a posture of the mission apparatus and flight information of a drone, to learn the video and the metainformation to detect an object, and to temporally synchronize coordinates of the detected object to generate metainformation comprising time coordinates of the object;
a drone (200) configured to apply a predetermined format and specifications to the metainformation and the video to generate low-capacity data and to transmit the low-capacity data to a ground controller within a limited frequency band; and
a ground controller (300) configured to restore the video utilizing the format and the specifications applied to the low-capacity data, to recognize an object pre-learned by the mission apparatus utilizing the metainformation, when a specific object is designated, to enhance a resolution of an image comprising the specific object to generate a designated image, and to provide the designated image to the drone for real-time tracking of the specific object, wherein
the mission apparatus, the drone, and the ground controller perform object detection or tracking using artificial intelligence-based edge computing,
the mission apparatus comprises:
an image processing unit (110) configured such that a plurality of boards configured to process an image signal of an image sensor unit (111) comprising an EO sensor (111-1) and an IR sensor (111-2) is stacked, the image processing unit comprising a first case (115) configured to provide lens exposure of the image sensor unit;
a posture control unit (120) configured to receive gimbal information from a gimbal sensor unit included in the image processing unit and to generate posture adjustment control information using the gimbal information; and
a posture adjustment unit (130) configured to connect the image processing unit and the posture control unit to each other and to adjust a posture of the image processing unit using the posture adjustment control information, and
the posture adjustment unit comprises an X-axis adjustment means (131) comprising an X-axis motor (131-1) disposed on one side of the first case adjacent to the EO sensor and an X-axis bearing (131-2) disposed on the other side of the first case adjacent to the IR sensor.

2. The autonomous flight system according to claim 1, wherein
the mission apparatus directly processes the image and the metainformation to reduce image signal loss or transmission delay, and detects an object in advance to increase accuracy of object recognition at the ground controller,
the drone provides low-capacity data to which the predetermined format and specifications are applied to the ground controller to reduce transmission delay or video stuttering within a limited bandwidth, and
the ground controller transmits the designated image to the drone within a predetermined time by restoring the video and recognizing a pre-learned object.

3. The autonomous flight system according to claim 1, wherein the drone generates low-capacity data by applying an SRT protocol using bit rate techniques and frame rate specifications to the video comprising the metainformation, thereby performing swarm communication with neighboring drones and sharing a limited frequency band.

4. The autonomous flight system according to claim 1, wherein
when the specific object is designated, the ground controller learns feature points of a pre-learned object to search for the specific object, enhances a resolution of an image comprising the searched specific object to generate a designated image, and provides information regarding coordinates of the specific object and the designated image to the drone, and
the drone tracks the specific object utilizing the coordinates of the specific object and the designated image provided by the ground controller, and if the specific object moves during an autonomous flight tracking process, fuses metainformation acquired during the tracking process with the image of the mission apparatus.
